(19) United States
(12) Patent Application Publication
(10) Pub. No.: US 2025/0239010 A1
(43) Pub. Date: Jul. 24, 2025

(54) SACCADE CONTINGENT REDUCED RESOLUTION RENDERING

(71) Applicant: Meta Platforms Technologies, LLC, Menlo Park, CA (US)

(72) Inventors: Phillip GUAN, Seattle, WA (US); Yuna Kwak, Long Island City, NY (US); Thomas Scott Murdison, Seattle, WA (US); Xiuyun Wu, Redmond, WA (US); Mohammadreza Saeedpourparizi, San Francisco, CA (US); Olivier Mercier, Redmond, WA (US)

(73) Assignee: Meta Platforms Technologies, LLC, Menlo Park, CA (US)

(21) Appl. No.: 19/012,634

(22) Filed: Jan. 7, 2025

Related U.S. Application Data
(60) Provisional application No. 63/622,304, filed on Jan. 18, 2024.

(51) Int. Cl. G06T 17/00; G06F 3/01; G06T 3/40

(52) U.S. Cl. CPC G06T 17/00; G06F 3/013; G06T 3/40

(57) ABSTRACT

Augmented and/or virtual reality (AR/VR) near-eye display devices implementing adjustment of rendering quality based on saccade detection to preserve computational and power resources are disclosed. In examples, an eye tracking system for an augmented reality/virtual reality (AR/VR) display device comprises a display to render content, an eye tracking system to capture a user's gaze, and a controller to manage the display and the eye tracking system. The controller may detect a saccade based on capturing a shift in the user's gaze, reduce a rendering quality of the rendered content for a duration of a post-saccade window; and increase the rendering quality upon completion of the post-saccade window.

### PRIORITY

The present application claims priority to U.S. provisional patent application Ser. No. 63/622,304, filed on Jan. 18, 2024, which is incorporated by reference in its entirety.

### TECHNICAL FIELD

This patent application relates generally to augmented and/or virtual reality (AR/VR) near-eye display devices, and in particular, to adjustment of rendering quality based on saccade detection to preserve computational and power resources.

### BACKGROUND

With recent advances in technology, prevalence and proliferation of content creation and delivery has increased greatly in recent years. In particular, interactive content such as virtual reality (VR) content and/or augmented reality (AR) content, and content within and associated with a real and/or virtual environment (e.g., a “metaverse”) has become appealing to consumers.

To facilitate delivery of this and other related content, service providers have endeavored to provide various forms of wearable display systems. One such example may be a head-mounted display (HMD) device, such as a wearable eyewear, a wearable headset, or eyeglasses. In some examples, the head-mounted display (HMD) device may project or direct light to display virtual objects or combine images of real objects with virtual objects, as in virtual reality (VR) and/or augmented reality (AR) applications. For example, in an AR system, a user may view both images of virtual objects (e.g., computer-generated images (CGIs)) and the surrounding environment. Head-mounted display (HMD) devices may also present interactive content, where a user's (wearer's) gaze may be used as input for the interactive content.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of a virtual reality (VR) and/or augmented reality (AR) system environment including a near-eye display, according to an example.

FIGS. 2A-2C illustrate various views of a near-eye display device in the form of a head-mounted display (HMD) device, according to examples.

FIG. 3 illustrates a perspective view of a near-eye display in the form of a pair of glasses, according to an example.

FIG. 4 illustrates change of user's focus on a displayed augmented reality (AR)/virtual reality (VR) scene, according to an example.

FIG. 5 illustrates adjustment of rendering quality based on saccade detection to preserve computational and power resources in an augmented reality (AR)/virtual reality (VR) system, according to examples.

FIG. 6 illustrates a flow diagram for a method of adjustment of rendering quality based on saccade detection to preserve computational and power resources in an augmented reality (AR)/virtual reality (VR) system, according to some examples.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

To provide comfortable and immersive experiences, high resolution, wide field of view displays are used in head-mounted AR/VR devices. Such displays require a large number of pixels. Rendering at high frame rates (e.g., higher than 90 Hz) and high resolution may be very costly regarding computational and power resources, both of which can be limited in head-mounted devices.

In some examples of the present disclosure, rendering quality including resolution and/or frame rate may be reduced during a post-saccade window following a user's change of gaze (or focus) on displayed content. A number of saccades per second and the duration of the post-saccade window may vary depending on user. Thus, the duration over which the rendering quality reduction may take place may also be adjusted. For example, the post-saccade window may range from one hundred (100) milliseconds (ms) to four hundred (400) milliseconds (ms). In some examples, the change in rendering quality may be dynamic, that is, instead of a binary reduction, the rendering quality may be reduced and then increased following a pre-defined ramp-up profile during the post-saccade window.

Some advantages and benefits of the present disclosure may include conservation of power and conservation of computational resources due to reduced rendering quality in head-mounted AR/VR devices, where both are in limited supply.

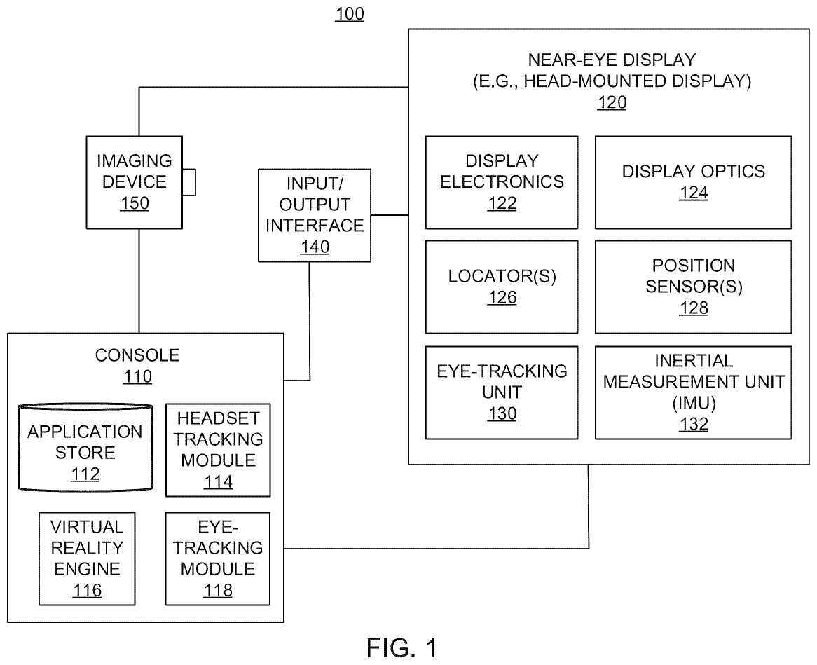

FIG. 1 illustrates a block diagram of a virtual reality (VR) and/or augmented reality (AR) system environment 100 including a near-eye display, according to an example. As used herein, a “near-eye display” may refer to a device (e.g., an optical device) that may be in close proximity to a user's eye. As used herein, “artificial reality” may refer to aspects of, among other things, a “metaverse” or an environment of real and virtual elements and may include use of technologies associated with virtual reality (VR) and/or augmented reality (AR), combination of which may be referred to as mixed reality (MR). As used herein a “user” may refer to a user or wearer of a “near-eye display.”

As shown in FIG. 1, the artificial reality system environment 100 may include a near-eye display 120, an optional external imaging device 150, and an optional input/output interface 140, each of which may be coupled to a console 110. The console 110 may be optional in some instances as the functions of the console 110 may be integrated into the near-eye display 120. In some examples, the near-eye display 120 may be a head-mounted display (HMD) that presents content to a user.

In some instances, for a near-eye display system, it may generally be desirable to expand an eye box, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular head-mounted display (HMD)) or both eyes (for binocular head-mounted displays (HMDs)). As used herein, an “eye box” may be a two- or three-dimensional box that may be positioned in front of the user's eye from which a displayed image from an image source may be viewed.

In some examples, in a near-eye display system, light from a surrounding environment may traverse a “see-through” region of a waveguide display (e.g., a transparent substrate) to reach a user's eyes. For example, in a near-eye display system, light of projected images may be coupled into a transparent substrate of a waveguide, propagate within the waveguide, and be coupled or directed out of the waveguide at one or more locations to replicate exit pupils and expand the eye box.

In some examples, the near-eye display 120 may include one or more rigid bodies that may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

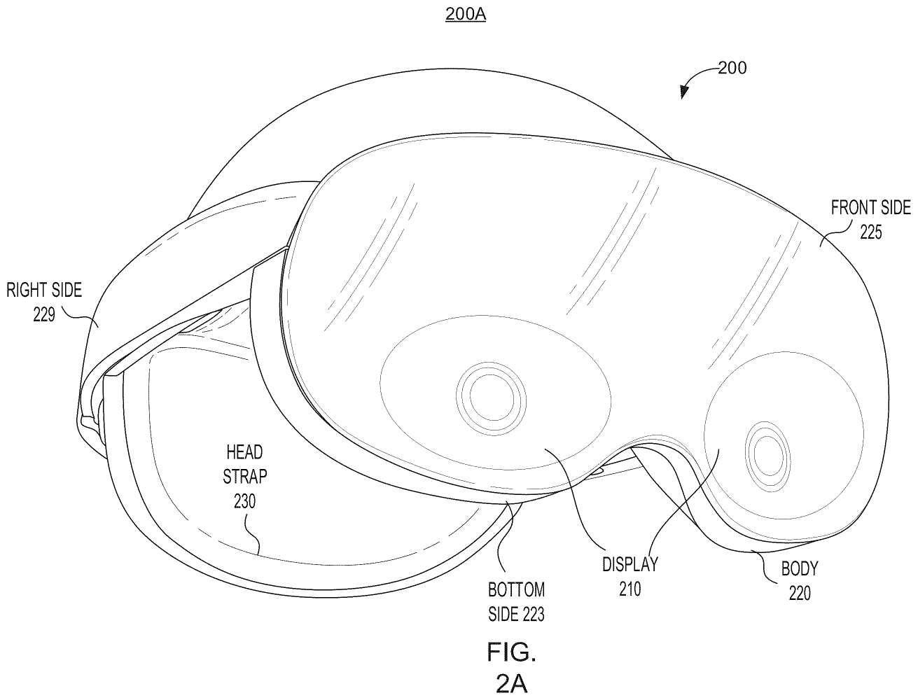

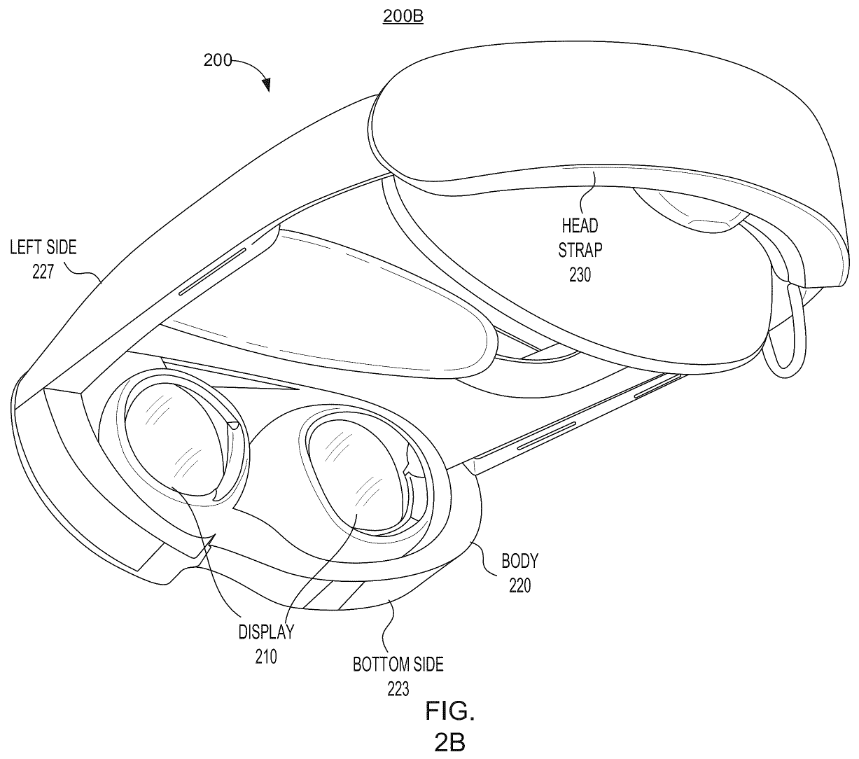

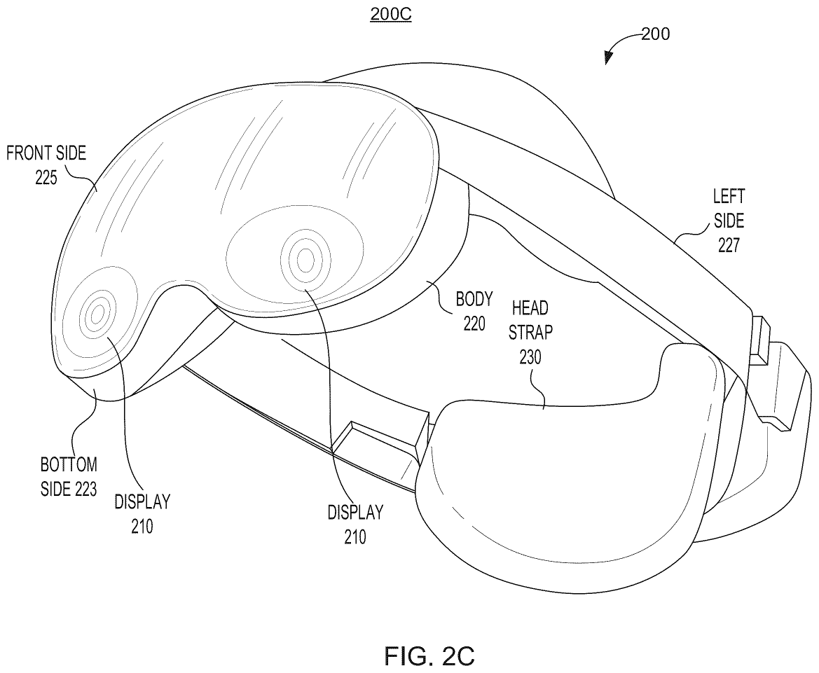

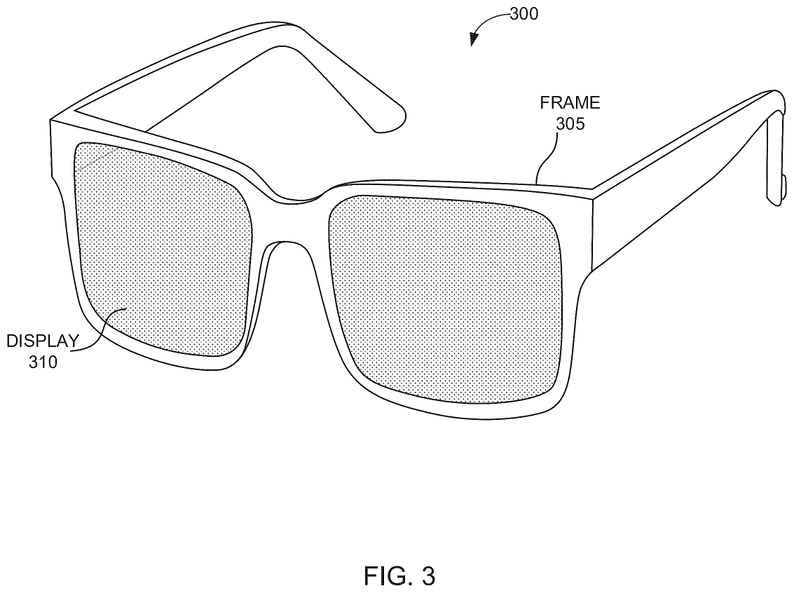

In some examples, the near-eye display 120 may be implemented in any suitable form-factor, including a head-mounted display (HMD), a pair of glasses, or other similar wearable eyewear or device. Examples of the near-eye display 120 are further described below with respect to FIGS. 2 and 3. Additionally, in some examples, the functionality described herein may be used in a head-mounted display (HMD) or headset that may combine images of an environment external to the near-eye display 120 and artificial reality content (e.g., computer-generated images). Therefore, in some examples, the near-eye display 120 may augment images of a physical, real-world environment external to the near-eye display 120 with generated and/or overlaid digital content (e.g., images, video, sound, etc.) to present an augmented reality to a user.

In some examples, the near-eye display 120 may include any number of display electronics 122, display optics 124, and an eye tracking unit 130. In some examples, the near-eye display 120 may also include one or more locators 126, one or more position sensors 128, and an inertial measurement unit (IMU) 132. In some examples, the near-eye display 120 may omit any of the eye tracking unit 130, the one or more locators 126, the one or more position sensors 128, and the inertial measurement unit (IMU) 132, or may include additional elements.

In some examples, the display electronics 122 may display or facilitate the display of images to the user according to data received from, for example, the optional console 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the near-eye display 120 may include a projector (not shown), which may form an image in angular domain for direct observation by a viewer's eye through a pupil. The projector may employ a controllable light source (e.g., a laser source) and a micro-electromechanical system (MEMS) beam scanner to create a light field from, for example, a collimated light beam. In some examples, the same projector or a different projector may be used to project a fringe pattern on the eye, which may be captured by a camera and analyzed (e.g., by the eye tracking unit 130) to determine a position of the eye (the pupil), a gaze, etc.

In some examples, the display optics 124 may display image content optically (e.g., using optical waveguides and/or couplers) or magnify image light received from the display electronics 122, correct optical errors associated with the image light, and/or present the corrected image light to a user of the near-eye display 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display optics 124 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 126 may be objects located in specific positions relative to one another and relative to a reference point on the near-eye display 120. In some examples, the optional console 110 may identify the one or more locators 126 in images captured by the optional external imaging device 150 to determine the artificial reality headset's position, orientation, or both. The one or more locators 126 may each be a light-emitting diode (LED), a corner cube deflector, a reflective marker, a type of light source that contrasts with an environment in which the near-eye display 120 operates, or any combination thereof.

In some examples, the external imaging device 150 may include one or more cameras, one or more video cameras, any other device capable of capturing images including the one or more locators 126, or any combination thereof. The optional external imaging device 150 may be configured to detect light emitted or reflected from the one or more locators 126 in a field of view of the optional external imaging device 150.

In some examples, the one or more position sensors 128 may generate one or more measurement signals in response to motion of the near-eye display 120. Examples of the one or more position sensors 128 may include any number of accelerometers, gyroscopes, magnetometers, and/or other motion-detecting or error-correcting sensors, or any combination thereof.

In some examples, the inertial measurement unit (IMU) 132 may be an electronic device that generates fast calibration data based on measurement signals received from the one or more position sensors 128. The one or more position sensors 128 may be located external to the inertial measurement unit (IMU) 132, internal to the inertial measurement unit (IMU) 132, or any combination thereof. Based on the one or more measurement signals from the one or more position sensors 128, the inertial measurement unit (IMU) 132 may generate fast calibration data indicating an estimated position of the near-eye display 120 that may be relative to an initial position of the near-eye display 120. For example, the inertial measurement unit (IMU) 132 may integrate measurement signals received from accelerometers over time to estimate a velocity vector and integrate the velocity vector over time to determine an estimated position of a reference point on the near-eye display 120. Alternatively, the inertial measurement unit (IMU) 132 may provide the sampled measurement signals to the optional console 110, which may determine the fast calibration data.

The eye tracking unit 130 may include one or more eye tracking systems. As used herein, “eye tracking” may refer to determining an eye's position or relative position, including orientation, location, and/or gaze of a user's eye. In some examples, an eye tracking system may include an imaging system that captures one or more images of an eye and may optionally include a light emitter, which may generate light (e.g., a fringe pattern) that is directed to an eye such that light reflected by the eye may be captured by the imaging system (e.g., a camera).

In some examples, the near-eye display 120 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye tracking unit 130 may be able to determine where the user is looking or predict any user patterns, etc.

In some examples, the input/output interface 140 may be a device that allows a user to send action requests to the optional console 110. As used herein, an “action request” may be a request to perform a particular action. For example, an action request may be to start or to end an application, or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110, which may perform an action corresponding to the requested action.

In some examples, the optional console 110 may provide content to the near-eye display 120 for presentation to the user in accordance with information received from one or more of external imaging device 150, the near-eye display 120, and the input/output interface 140. For example, in the example shown in FIG. 1, the optional console 110 may include an application store 112, a headset tracking module 114, a virtual reality engine 116, and an eye tracking module 118. Some examples of the optional console 110 may include different or additional modules than those described in conjunction with FIG. 1. Functions further described below may be distributed among components of the optional console 110 in a different manner than is described here.

In some examples, the optional console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 110 described in conjunction with FIG. 1 may be encoded as instructions in the non-transitory computer-readable storage medium that, when executed by the processor, cause the processor to perform the functions further described below. It should be appreciated that the optional console 110 may or may not be needed or the optional console 110 may be integrated with or separate from the near-eye display 120.

In some examples, the application store 112 may store one or more applications for execution by the optional console 110. An application may include a group of instructions that, when executed by a processor, generates content for presentation to the user. Examples of the applications may include gaming applications, conferencing applications, video playback application, or other suitable applications.

In some examples, the headset tracking module 114 may track movements of the near-eye display 120 using slow calibration information from the external imaging device 150. For example, the headset tracking module 114 may determine positions of a reference point of the near-eye display 120 using observed locators from the slow calibration information and a model of the near-eye display 120. Additionally, in some examples, the headset tracking module 114 may use portions of the fast calibration information, the slow calibration information, or any combination thereof, to predict a future location of the near-eye display 120. In some examples, the headset tracking module 114 may provide the estimated or predicted future position of the near-eye display 120 to the virtual reality engine 116.

In some examples, the virtual reality engine 116 may execute applications within the artificial reality system environment 100 and receive position information of the near-eye display 120, acceleration information of the near-eye display 120, velocity information of the near-eye display 120, predicted future positions of the near-eye display 120, or any combination thereof from the headset tracking module 114. In some examples, the virtual reality engine 116 may also receive estimated eye position and orientation information from the eye tracking module 118. Based on the received information, the virtual reality engine 116 may determine content to provide to the near-eye display 120 for presentation to the user.

In some examples, a location of a projector of a display system may be adjusted to enable any number of design modifications. For example, in some instances, a projector may be located in front of a viewer's eye (i.e., “front-mounted” placement). In a front-mounted placement, in some examples, a projector of a display system may be located away from a user's eyes (i.e., “world-side”). In some examples, a head-mounted display (HMD) device may utilize a front-mounted placement to propagate light towards a user's eye(s) to project an image.

As mentioned herein, rendering quality including resolution and/or frame rate may be reduced during a post-saccade window following a user's change of gaze (or focus) on displayed content to conserve power consumption and computational resources. A number of saccades per second and the duration of the post-saccade window may vary depending on user. Thus, the duration of rendering quality reduction may also be adjusted.

FIGS. 2A-2C illustrate various views of a near-eye display device in the form of a head-mounted display (HMD) device 200, according to examples. In some examples, the head-mounted device (HMD) device 200 may be a part of a virtual reality (VR) system and/or an augmented reality (AR) system, another system that uses displays or wearables, or any combination thereof. As shown in diagram 200A of FIG. 2A, the head-mounted display (HMD) device 200 may include a body 220 and a head strap 230. The front perspective view of the head-mounted display (HMD) device 200 further shows a bottom side 223, a front side 225, and a right side 229 of the body 220. In some examples, the head strap 230 may have an adjustable or extendible length. In particular, in some examples, there may be a sufficient space between the body 220 and the head strap 230 of the head-mounted display (HMD) device 200 for allowing a user to mount the head-mounted display (HMD) device 200 onto the user's head. For example, the length of the head strap 230 may be adjustable to accommodate a range of user head sizes. In some examples, the head-mounted display (HMD) device 200 may include additional, fewer, and/or different components such as a display 210 to present a wearer augmented reality (AR)/virtual reality (VR) content and a camera to capture images or videos of the wearer's environment.

As shown in the bottom perspective view of diagram 200B of FIG. 2B, the display 210 may include one or more display assemblies and present, to a user (wearer), media or other digital content including virtual and/or augmented views of a physical, real-world environment with computer-generated elements. Examples of the media or digital content presented by the head-mounted display (HMD) device 200 may include images (e.g., two-dimensional (2D) or three-dimensional (3D) images), videos (e.g., 2D or 3D videos), audio, or any combination thereof. In some examples, the user may interact with the presented images or videos through eye tracking sensors enclosed in the body 220 of the head-mounted display (HMD) device 200. The eye tracking sensors may also be used to adjust and improve quality of the presented content.

In some examples, the head-mounted display (HMD) device 200 may include various sensors (not shown), such as depth sensors, motion sensors, position sensors, and/or eye tracking sensors. Some of these sensors may use any number of structured or unstructured light patterns for sensing purposes. In some examples, the head-mounted display (HMD) device 200 may include an input/output interface for communicating with a console communicatively coupled to the head-mounted display (HMD) device 200 through wired or wireless means. In some examples, the head-mounted display (HMD) device 200 may include a virtual reality engine (not shown) that may execute applications within the head-mounted display (HMD) device 200 and receive depth information, position information, acceleration information, velocity information, predicted future positions, or any combination thereof of the head-mounted display (HMD) device 200 from the various sensors.

In some examples, the information received by the virtual reality engine may be used for producing a signal (e.g., display instructions) to the display 210. In some examples, the head-mounted display (HMD) device 200 may include locators (not shown), which may be located in fixed positions on the body 220 of the head-mounted display (HMD) device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

It should be appreciated that in some examples, a projector mounted in a display system may be placed near and/or closer to a user's eye (i.e., “eye-side”). In some examples, and as discussed herein, a projector for a display system shaped like eyeglasses may be mounted or positioned in a temple arm (i.e., a top far corner of a lens side) of the eyeglasses. It should be appreciated that, in some instances, utilizing a back-mounted projector placement may help to reduce size or bulkiness of any required housing required for a display system, which may also result in a significant improvement in user experience for a user.

In some examples, rendering quality including resolution and/or frame rate may be reduced during a post-saccade window following a user's change of gaze (or focus) on displayed content. Furthermore, the duration of rendering quality reduction may also be adjusted. In other examples, the change in rendering quality may be dynamic, that is, instead of a binary reduction, the rendering quality may be reduced and then increased following a pre-defined ramp-up profile during the post-saccade window.

FIG. 3 is a perspective view of a near-eye display 300 in the form of a pair of glasses (or other similar eyewear), according to an example. In some examples, the near-eye display 300 may be a specific example of near-eye display 120 of FIG. 1 and may be configured to operate as a virtual reality display and/or an augmented reality (AR) display.

In some examples, the near-eye display 300 may include a frame 305 and a display 310. In some examples, the display 310 may be configured to present media or other content to a user. In some examples, the display 310 may various include display electronics and/or display optics (e.g., an eye tracking component as described herein), similar to components described with respect to FIGS. 1 and 2A-2C. For example, as described above with respect to the near-eye display 120 of FIG. 1, the display 310 may include a liquid crystal display (LCD) display panel, a light-emitting diode (LED) display panel, or an optical display panel (e.g., a waveguide display assembly). In some examples, the display 310 may also include any number of optical components, such as waveguides, gratings, lenses, mirrors, etc. In other examples, the display 310 may include a projector, or in place of the display 310, the near-eye display 300 may include a projector.

In some examples, the near-eye display 300 may further include various sensors on or within a frame 305. In some examples, the various sensors may include any number of depth sensors, motion sensors, position sensors, inertial sensors, and/or ambient light sensors, as shown. In some examples, the various sensors may include any number of image sensors configured to generate image data representing different fields of views in one or more different directions. In some examples, the various sensors may be used as input devices to control or influence the displayed content of the near-eye display, and/or to provide an interactive virtual reality (VR) and/or augmented reality (AR) experience to a user of the near-eye display 300. In some examples, the various sensors may also be used for stereoscopic imaging or other similar applications.

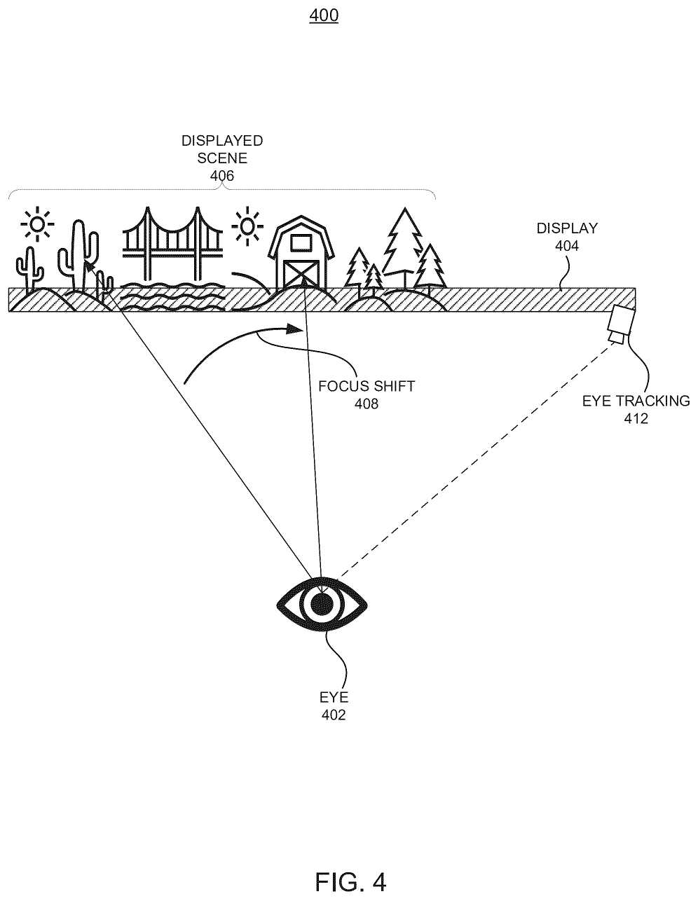

FIG. 4 illustrates change of user's focus on a displayed augmented reality (AR)/virtual reality (VR) scene, according to an example.

As mentioned herein, an AR/VR display 404 presents virtual or augmented content (displayed scene 406) to a user (eye 402). An AR/VR device may provide a number of functionalities such as presenting additional content, taking an action (e.g., changing displayed content, establishing a communication, etc.) in response to user input. A commonly used user input in AR/VR devices is user's gaze, which may be tracked by an eye tracking system 412 (e.g., a projector, a camera, and a processor). The eye tracking system 412 may capture user's gaze over time, and the AR/VR system may perform predefined actions based on the user's gaze.

For a comfortable and immersive experience, the AR/VR device may employ a high resolution, wide field of view display. To provide enhanced rendering quality, high number of pixels and high frame rates may be used. However, both of those result in increased power consumption and increased computational resources, both of which are typically in limited supply in head-mounted display devices.

Visual acuity is highest at the fovea, a central region of the retina. The foveal region has the highest density of photoreceptors that allows parts of the visual field that fall on it to be seen with the highest detail. Outside the foveal region, visual acuity drops gradually towards the edges of the retina.

To see the entire visual field in high acuity, the visual field is scanned with successive eye movements known as saccades and the high acuity snapshots of the scene are integrated in a process known as trans-saccadic integration. Saccadic velocities may reach as high as 400 to 600 degrees per second, with durations lasting from thirty (30) to one-hundred twenty (120) milliseconds (ms), and amplitudes in the range one (1) to forty-five (45) degrees. Under natural circumstances, gaze shifts of greater than about thirty (30) degrees are typically achieved by a combination of saccade and head movement. Vision is typically blurred during a saccade, which may allow for manipulation of the visual scene to go largely unnoticed during the saccades.

After a saccade, the eyes typically remain relatively still for an average duration of two hundred (200) milliseconds (ms) to three hundred (300) milliseconds (ms) to fixate on objects of interest in the scene (focus shift 408). Capturing fixation locations and analyzing them may provide information about a user's attentional state and a scene or content that the user may be interested in. The AR/VR device may then use the information to perform actions such as those described herein.

When a person is fixating, the eyes make very small eye movements called micro-saccades. These small eye movements jitter the photoreceptor mosaic by a very small amount and over time improve visual acuity compared to an eye that does not move at all. This means that once a saccade is finished (and saccadic suppression is over), the visual acuity is slightly lower since the very small eye movements did not occur during the saccade. As time progresses (a few hundred milliseconds) and the very small eye movements occur, visual acuity improves. Example implementations may take advantage of this phenomenon by specifically targeting a time period after a saccade landing and gradually ramping up the rendering resolution as the micro-saccades occur.

In some examples, rendering quality may be reduced during the post-saccade window following a user's change of gaze captured by the eye tracking system. The post-saccade window (different from the relatively still period discussed above) may range from one hundred (100) milliseconds (ms) to four hundred (400) milliseconds (ms). In some examples, the change in rendering quality may be dynamic, that is, instead of a binary reduction, the rendering quality may be reduced and then increased following a pre-defined ramp-up profile during the post-saccade window. Furthermore, it may be appreciated that if in instances where an eye tracking component may not be functioning or otherwise saccade detection may be not be taking place or taking place correctly, a display system as described herein may default to other (typical) known rendering methods.

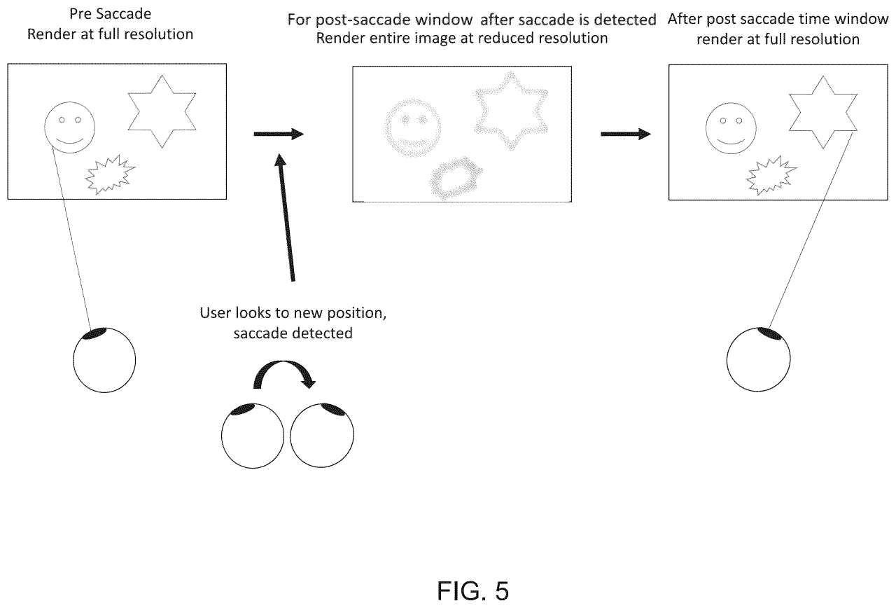

FIG. 5 illustrates adjustment of rendering quality based on saccade detection to preserve computational and power resources in an augmented reality (AR)/virtual reality (VR) system, according to examples.

Diagram 500 shows conceptually the process of adjusting rendering quality based on saccades. The human visual system is not equally sensitive to all of the pixels in rendered content spatially and temporally, and this sensitivity depends on the position and movement of the eye. Furthermore, visual acuity at fixation may be reduced after rapidly changing gaze from one point to another (the saccade). Thus, following a saccade, rendering can be reduced to approximately fifteen (15) to twenty (20) cycles per degree for one hundred (100) milliseconds (ms) to four hundred (400) milliseconds (ms). On average three (3) to five (5) saccades are made each second. So, this approach may be employed for a substantial amount of time over natural viewing in a head-mounted display.

It should be noted that this reduced spatial acuity occurs at the fovea. Thus, the entire image may be rendered in lower resolution over time. This may be complimentary to foveated rendering, which renders in lower resolution over space, away from a user's fixation.

As shown in the diagram 500, the content is rendered pre-saccade at full quality (i.e., full resolution and frame rate). When the user changes their gaze to a new location, a saccade is detected. For the post-saccade window, after the saccade is detected, the entire image may be rendered in reduced quality (resolution and/or frame rate). In some examples, the rendering quality reduction may be dynamic (e.g., gradual). After the post-saccade window, the content may be rendered in full quality again. Similar to the reduction, the increase in rendering quality may also be binary or dynamic (e.g., following a predefined profile).

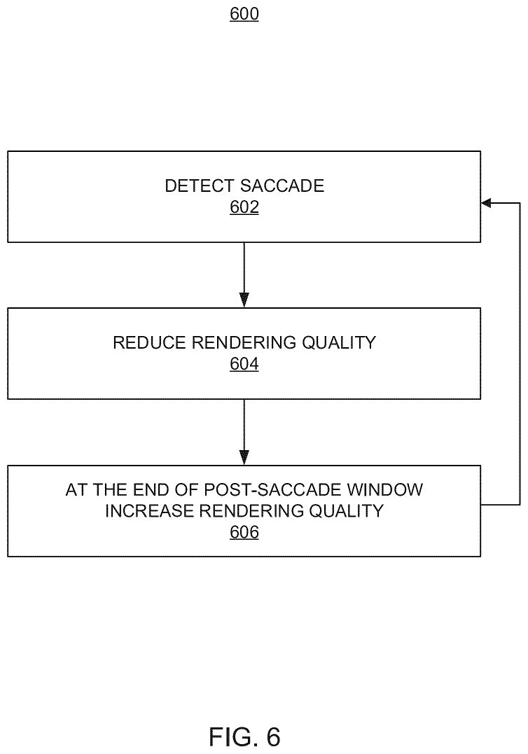

FIG. 6 illustrates a flow diagram for a method of adjustment of rendering quality based on saccade detection to preserve computational and power resources in an augmented reality (AR)/virtual reality (VR) system, according to some examples. The method 600 is provided by way of example, as there may be a variety of ways to carry out the method described herein. Although the method 600 is primarily described as being performed by the components of FIG. 1, the method 600 may be executed or otherwise performed by one or more processing components of another system or a combination of systems. Each block shown in FIG. 6 may further represent one or more processes, methods, or subroutines, and one or more of the blocks may include machine readable instructions stored on a non-transitory computer readable medium and executed by a processor or other type of processing circuit to perform one or more operations described herein.

At block 602, a change in the gaze of a user, thus a saccade, may be detected. Following the saccade, rendering quality, resolution and/or frame rate, may be reduced at block 604 for the duration of a post-saccade window, for example, one hundred (100) milliseconds (ms) to four hundred (400) milliseconds (ms). It may be appreciated that, for certain examples described herein, while saccade detection may be necessary, this detection may be accomplished via a variety of techniques and/or technical arrangements. Furthermore, in some examples, while lower latency detection(s) may be beneficial in some contexts, latencies associated with saccade detection may not necessarily directly impact the examples and techniques described herein.

The duration of the post-saccade window may vary between individuals. Thus, a calibration or measurement process may be employed to customize the post-saccade window duration to a specific user. At block 606, the rendering quality may be increased to full quality at the end of the post-saccade window. In some examples, the change in rendering quality may be dynamic, that is, instead of a binary reduction, the rendering quality may be reduced and then increased following a pre-defined ramp-up profile during the post-saccade window. Accordingly, by implementing saccade detection and saccade-contingent rendering (e.g., in conjunction with eye tracking features already implemented on a display device), the systems and methods described herein may provide additional power (i.e., compute) savings during rendering.

According to examples, methods of adjusting rendering quality based on saccade detection to preserve computational and power resources in an augmented reality (AR)/virtual reality (VR) system are described herein. Systems of adjusting rendering quality based on saccade detection in an augmented reality (AR)/virtual reality (VR) system are also described herein. A non-transitory computer-readable storage medium may have an executable stored thereon, which when executed instructs a processor to perform the methods described herein. It may be appreciated that, as discussed above, the saccade contingent rendering techniques described herein may provide a number of benefits, including but not limited to reduction(s) in power consumption and reduced in heat generation for display systems.

In the foregoing description, various examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. An augmented reality/virtual reality (AR/VR) display device, comprising:
a display to render content;
an eye tracking system to capture a user's gaze; and
a controller to manage the display and the eye tracking system, wherein the controller is to:
detect a saccade based on capturing a shift in the user's gaze;
reduce a rendering quality of the rendered content for a duration of a post-saccade window; and
increase the rendering quality upon completion of the post-saccade window.

2. The AR/VR display device of claim 1, wherein duration of the post-saccade window is in a range from one hundred (100) milliseconds to four hundred (400) milliseconds.

3. The AR/VR display device of claim 1, wherein the duration of the post-saccade window is customized for the user.

4. The AR/VR display device of claim 1, wherein the rendering quality includes one or more of a resolution or a frame rate.

5. The AR/VR display device of claim 1, wherein the controller is to increase the rendering quality to full quality upon completion of the post-saccade window in a binary manner.

6. The AR/VR display device of claim 1, wherein the controller is to increase the rendering quality to full quality upon completion of the post-saccade window following a ramp-up profile.

7. The AR/VR display device of claim 6, wherein the ramp-up profile is customized for the user.

8. A method for an augmented reality/virtual reality (AR/VR) display device, the method, comprising:
rendering content through a display of the AR/VR display device at full rendering quality;
detecting a saccade based on capturing a shift in a user's gaze through an eye tracking system;
reducing a rendering quality of the rendered content for a duration of a post-saccade window; and
increasing the rendering quality to the full rendering quality upon completion of the post-saccade window.

9. The method of claim 8, further comprising:
selecting a duration of the post-saccade window from a range from one hundred (100) milliseconds to four hundred (400) milliseconds.

10. The method of claim 8, further comprising,
customizing the duration of the post-saccade window for the user.

11. The method of claim 8, wherein the rendering quality includes one or more of a resolution or a frame rate.

12. The method of claim 8, further comprising,
increasing the rendering quality to the full rendering quality upon completion of the post-saccade window in a binary manner.

13. The method of claim 8, further comprising,
increasing the rendering quality to the full rendering quality upon completion of the post-saccade window following a ramp-up profile.

14. The method of claim 13, further comprising:
customizing the ramp-up profile or the user.

15. A non-transitory computer readable medium configured to store program code instructions, when executed by a processor, cause the processor to perform steps comprising:
detect a saccade based on capturing a shift in a user's gaze;
reduce a rendering quality of rendered content for a duration of a post-saccade window; and
increase the rendering quality upon completion of the post-saccade window.

16. The non-transitory computer readable medium of claim 15, wherein the instructions, when executed by the processor, cause the processor to increase the rendering quality to full quality upon completion of the post-saccade window in a binary manner.

17. The non-transitory computer readable medium of claim 15, wherein the instructions, when executed by the processor, cause the processor to increase the rendering quality to full quality upon completion of the post-saccade window following a ramp-up profile.

18. The non-transitory computer readable medium of claim 17, wherein the ramp-up profile is customized for the user.

19. The non-transitory computer readable medium of claim 15, wherein a duration of the post-saccade window is in a range from one hundred (100) milliseconds to four hundred (400) milliseconds.

20. The non-transitory computer readable medium of claim 15, wherein the instructions, when executed by the processor, cause the processor to receive input associated with customizing a duration of the post-saccade window.
